(19) United States
(12) Patent Application Publication
(10) Pub. No.: US 2014/0368562 A1
(43) Pub. Date: Dec. 18, 2014

(54) DISPLAY DEVICE HAVING IMPROVED CONTRAST RATIO

(71) Applicant: Samsung Display Co., ltd., Yongin-City (KR)

(72) Inventors: Yeon-Sung KIM, Suwon-si, Gyeonggi-do (KR); Seung-Won KUK, Asan-si, Chungcheongnam-do (KR); YUNJAE PARK, Seoul (KR); Sanghyuk KIM, Cheonan-si, Chungcheongnam-do (KR); Gyusu LEE, Asan-si, Chungcheongnam-do (KR); Jikhan JUNG, Seoul (KR)

(73) Assignee: Samsung Display Co., Ltd., Yongin-City (KR)

(21) Appl. No.: 14/090,609

(22) Filed: Nov. 26, 2013

(30) Foreign Application Priority Data
Jun. 13, 2013 (KR) 10-2013-0067873

(51) Int. Cl. G09G 3/36

(52) U.S. Cl. CPC G09G 3/3607
USPC 345/694; 345/89

(57) ABSTRACT

A display device includes a display panel, a gray-scale voltage generator, and a data driver. The data driver includes a first amplifier. The first amplifier includes a first voltage input terminal configured to receive a first voltage, a second voltage input terminal configured to receive a second voltage lower than both the first voltage and a common voltage to be applied to a pixel included in the display panel, an input terminal configured to receive a gray-scale voltage having a gray-scale level corresponding to image data, and an output terminal configured to output the data voltage as a buffered voltage corresponding to the gray-scale voltage.

### CROSS-REFERENCE TO RELATED APPLICATION

This U.S. non-provisional patent application claims priority under 35 U.S.C. §119 to Korean Patent Application No. 10-2013-0067873, filed on Jun. 13, 2013, the contents of which are hereby incorporated by reference in their entirety.

### BACKGROUND

1. Field of Disclosure

The present disclosure relates generally to a display device. More particularly, the present disclosure relates to a display device having improved contrast ratio.

2. Description of the Related Art

A display device includes a display panel configured to include signal lines and pixels connected to the signal lines. In addition, the display device includes a driving circuit to drive the display panel.

Each of the pixels includes a pixel electrode and a common electrode which receive different voltages from each other. A light transmittance of the pixel is determined by an electric field formed between the pixel electrode and the common electrode as a result of the differing voltages.

In general, since the common electrode maintains a constant electric potential, light transmittance is determined by the pixel voltage applied to the pixel electrode. The gray-scale level of the pixel is determined by the light transmittance. When its light transmittance becomes low, the pixel displays a color at a low gray-scale level, and when the light transmittance becomes high, the pixel displays a color at a high gray-scale level.

### SUMMARY

The present disclosure provides a display device capable of reducing brightness in low gray-scale.

Embodiments of the inventive concept provide a display device including a display panel, a gray-scale voltage generator, and a data driver. The display panel includes a plurality of pixels and each of the pixels is configured to receive both a common voltage and a data voltage that corresponds to an image data. The gray-scale voltage generator is configured to generate a plurality of reference gray-scale voltages. The data driver is configured to receive the image data and the reference gray-scale voltages and to generate the data voltage.

The data driver includes a first amplifier. The first amplifier includes a first voltage input terminal configured to receive a first voltage, a second voltage input terminal configured to receive a second voltage lower than both the first voltage and the common voltage, an input terminal configured to receive a gray-scale voltage having a gray-scale level corresponding to the image data, and an output terminal configured to output the data voltage as a buffered voltage corresponding to the gray-scale voltage.

The gray-scale voltage generator is configured to receive the first voltage and a third voltage lower than the first voltage, and to generate the reference gray-scale voltages between the first voltage and the third voltage.

The reference gray-scale voltages include positive reference gray-scale voltages between the first voltage and the common voltage, and negative reference gray-scale voltages between the common voltage and the third voltage.

The second voltage is about 0.5 volts to about 1 volt less than that positive reference gray-scale voltage which has a lowest gray scale level from among the gray scale levels of the positive reference gray-scale voltages.

A voltage difference between the common voltage and that positive reference gray-scale voltage which has a lowest gray-scale level is about 0.5 volts.

That positive reference gray-scale voltage which has a lowest gray-scale level is substantially equal to the common voltage.

When the gray-scale level of the image data is the lowest gray-scale level, the gray-scale voltage applied to the input terminal of the first amplifier has the same level as that positive reference gray-scale voltage which has a lowest gray-scale level.

The display panel includes a plurality of gate lines connected to the pixels and a plurality of data lines connected to the pixels.

Each of the pixels includes a thin film transistor connected to a corresponding one of the gate lines and a corresponding one of the data lines, as well as a liquid crystal capacitor connected to the thin film transistor.

The liquid crystal capacitor includes a first electrode configured to receive a pixel voltage corresponding to the data voltage from the thin film transistor, as well as a second electrode configured to receive the common voltage.

The data driver includes a second amplifier having a first voltage input terminal configured to receive a fourth voltage higher than the common voltage and lower than the first voltage, a second voltage input terminal configured to receive the third voltage, an input terminal configured to receive the gray-scale voltage, and an output terminal configured to output the data voltage as a buffered voltage corresponding to the gray-scale voltage.

The first amplifier is configured to output its data voltage having a positive polarity, the second amplifier is configured to output its data voltage having a negative polarity, and the data driver is configured to output the positive polarity data voltage and the negative polarity data voltage in alternating manner.

The fourth voltage is about 0.5 volts to about 1 volt greater than that negative reference gray-scale voltage which has a lowest gray-scale level from among the gray scale levels of the negative reference gray-scale voltages.

A voltage difference between the common voltage and that negative reference gray-scale voltage which has a lowest gray-scale level is about 0.5 volts.

Embodiments of the inventive concept provide a data driver including a shift register, a latch, a digital-to-analog converter, and an output buffer. The shift register includes a plurality of stages connected to each other one after another and configured to sequentially output control signals. The latch is configured to receive image data and to store the image data in a pixel row unit in response to the control signals.

The digital-to-analog converter is configured to receive reference gray-scale voltages including positive reference gray-scale voltages and negative reference gray-scale voltages. The digital-to-analog converter is configured to convert the image data output from the latch to gray-scale voltages.

The output buffer is configured to output data voltages buffered from the gray-scale voltages to pixels of a display panel. The output buffer includes a plurality of buffer circuits.

Each of the buffer circuits includes a first amplifier and a second amplifier. Each of the buffer circuits includes a first switch and a second switch.

The first switch is configured to selectively apply the corresponding gray-scale voltage to either the input terminal of the first amplifier or the input terminal of the second amplifier, according to the polarity control signal.

The second switch is configured to selectively connect either the output terminal of the first amplifier or the output terminal of the second amplifier to a data line connected to the corresponding pixel, according to the polarity control signal.

According to the above, the data driver may utilize a voltage having a small voltage difference with respect to the common voltage as the positive or negative lowest reference gray-scale voltage. The brightness in the lowest gray-scale becomes lower due to the level of the positive or negative lowest reference gray-scale voltage, and thus the pixel displays a lowest gray-scale nearer to black. Thus, a contrast ratio of the display device becomes higher.

Even though the first and second amplifiers included in the buffer circuit receive a voltage having a small voltage difference with respect to the common voltage as the positive or negative lowest gray-scale voltage, the first and second amplifiers operate normally. Since the positive data voltage that represents the lowest gray-scale is output from the first amplifier at a level higher than that of the second voltage applied to the negative voltage input terminal even though the positive data voltage that represents the lowest gray-scale is output from the first amplifier at a level lower than that of the common voltage, the first amplifier operates normally.

### BRIEF DESCRIPTION OF THE DRAWINGS

The above and other advantages of the present disclosure will become readily apparent by reference to the following detailed description when considered in conjunction with the accompanying drawings wherein:

FIG. 1 is a block diagram showing a display device according to an exemplary embodiment of the present disclosure;

FIG. 2 is an equivalent circuit diagram showing a pixel shown in FIG. 1;

FIGS. 3A and 3B are timing diagrams showing signals generated in a display device according to an exemplary embodiment of the present disclosure;

FIG. 4 is a block diagram showing a gray-scale voltage generator shown in FIG. 1;

FIG. 5 is a circuit diagram showing a positive gray-scale voltage generator according to an exemplary embodiment of the present disclosure;

FIG. 6 is a gamma curve of a display device according to an exemplary embodiment of the present disclosure;

FIG. 7 is a block diagram showing a data driver of FIG. 1;

FIG. 8 is a circuit diagram showing an output buffer of FIG. 7; and

FIG. 9 is a gamma curve of a display device according to another exemplary embodiment of the present disclosure.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative tennis, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings, which are not necessarily to scale.

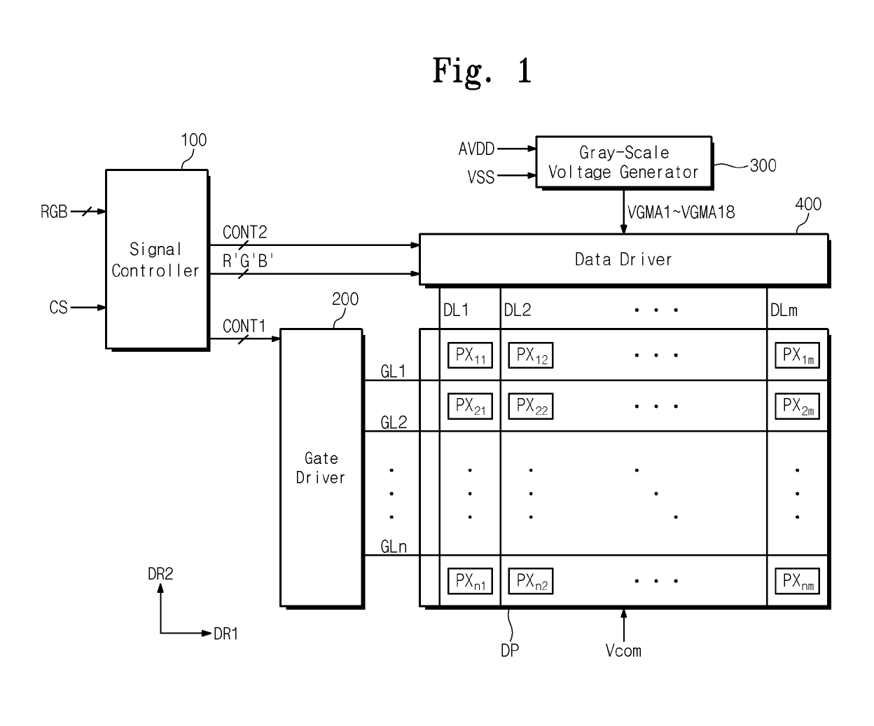

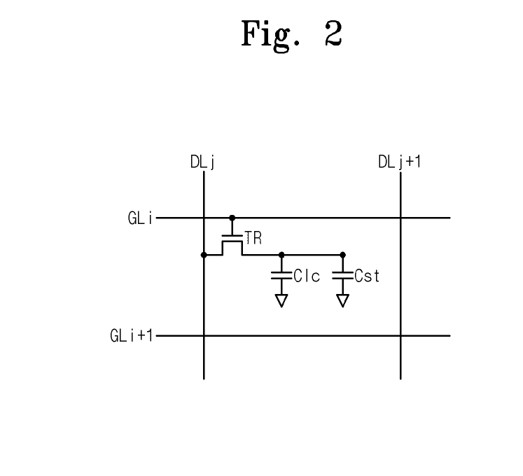

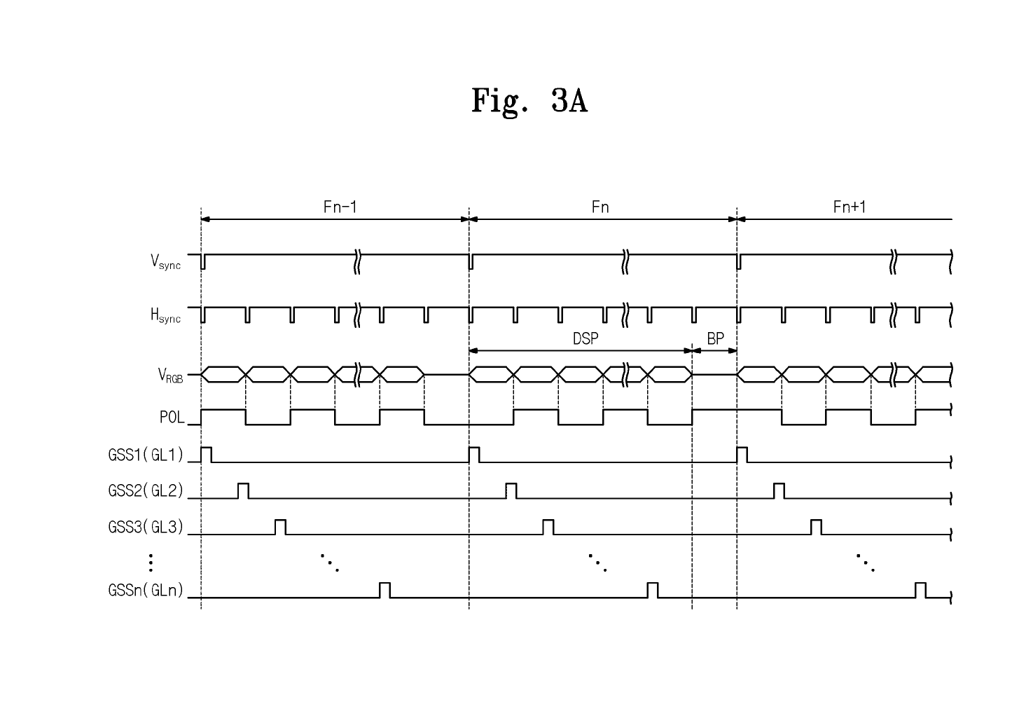

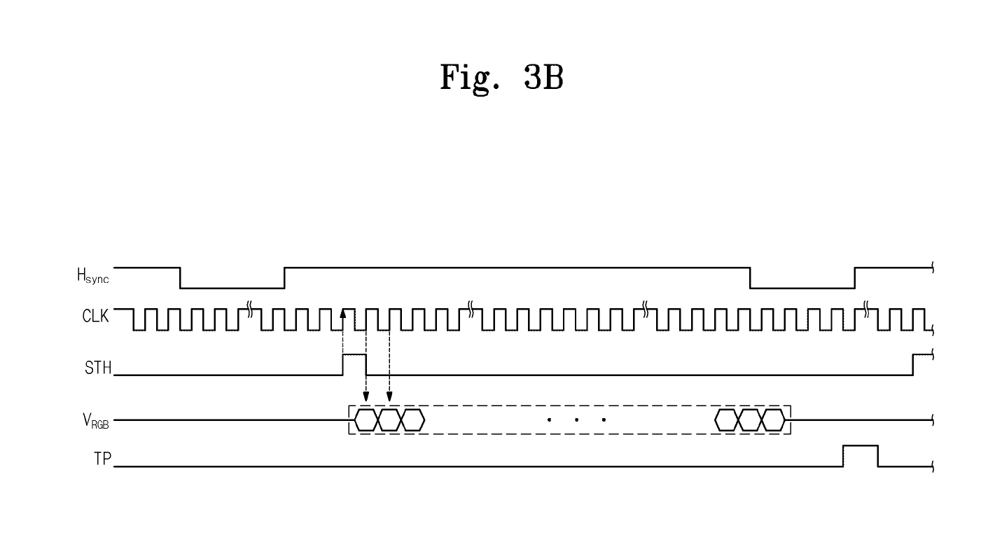

FIG. 1 is a block diagram showing a display device according to an exemplary embodiment of the present disclosure, FIG. 2 is an equivalent circuit diagram showing a pixel shown in FIG. 1, and FIGS. 3A and 3B are timing diagrams showing signals generated in a display device according to an exemplary embodiment of the present disclosure.

Referring to FIG. 1, the display device includes a display panel DP, a signal controller 100, a gate driver 200, a gray-scale voltage generator 300, and a data driver 400.

The display panel DP may be a transmissive type display panel such as a liquid crystal display panel, an electrophoretic display panel, an electrowetting display panel, etc., or it may be a reflective type display panel. In the present exemplary embodiment, the display panel DP is a liquid crystal display panel.

Although not shown in the figures, a liquid crystal display has a liquid crystal display panel that further includes a backlight unit (not shown) to supply light to the liquid crystal display panel, and a pair of polarizing plates (not shown). In addition, the liquid crystal display panel may be driven in any suitable mode, including a vertical alignment mode, a patterned vertical alignment mode, an in-plane switching mode, or a plane to line switching mode.

The display panel DP includes a plurality of gate lines GL1 to GLn, a plurality of data lines DL1 to DLm, and a plurality of pixels PX 11 to PXnm. The gate lines GL 1 to GLn extend in a first direction DR1 and arranged in a second direction DR2. The data lines DL1 to DLm are insulated from the gate lines GL1 to GLn while crossing the gate lines GL1 to GLn. The gate lines GL1 to GLn are connected to the gate driver 200 and the data lines DL1 to DLm are connected to the data driver 400.

The pixels PX11 to PXnm can be arranged in any manner, but are arranged here in matrix form. Each of the pixels PX11 to PXnm is connected to a corresponding gate line of the gate lines GL 1 to GLn and a corresponding data line of the data lines DL1 to DLm. The pixels PX11 to PXnm may be arranged in a pentile structure.

FIG. 2 is an equivalent circuit diagram showing a pixel PXij according to an exemplary embodiment of the present disclosure. Each of the pixels PX11 to PXnm has the equivalent circuit shown in FIG. 2.

The pixel PXij includes a thin film transistor TR, a liquid crystal capacitor Clc, and a storage capacitor Cst. The thin film transistor TR is electrically connected to an i-th gate line GLi and a j-th data line DLj. The thin film transistor TR outputs a pixel voltage corresponding to a data voltage provided through the j-th data line DLj in response to a gate signal provided through the i-th gate line GLi.

The liquid crystal capacitor Clc is charged with an electric charge corresponding to a difference between the pixel voltage and the common voltage. A first electrode of the liquid crystal capacitor Clc corresponds to the pixel electrode and a second electrode of the liquid crystal capacitor Clc corresponds to the common electrode. An alignment of liquid crystal directors (not shown) of a liquid crystal layer is varied in accordance with the amount of electric charge charged into the liquid crystal capacitor Clc. A light incident into the liquid crystal layer passes through the liquid crystal layer or is blocked according to the alignment of the liquid crystal directors. The pixel PXij thus displays a gray-scale corresponding to a level of the pixel voltage.

The storage capacitor Cst is connected to the liquid crystal capacitor Clc in parallel. The storage capacitor Cst maintains the alignment of the liquid crystal directors for a predetermined period.

The signal controller 100, the gate driver 200, the gray-scale voltage generator 300, and the data driver 400 control the display panel DP to thereby generate desired images.

The signal controller 100 receives input image signals RGB and converts the input image signals RGB to image data R′G′B′ appropriate to an operation of the display panel DP. In addition, the signal controller 100 receives various control signals CS, e.g., a vertical synchronizing signal Vsync, a horizontal synchronizing signal Hsync, a main clock signal, a data enable signal, etc., and outputs first and second control signals CONT1 and CONT2.

Referring to FIGS. 3A and 3B, the vertical synchronizing signal Vsync defines frame periods Fn−1, Fn, and Fn+1. Each of the frame periods Fn−1, Fn, and Fn+1 includes a display period DSP and a non-display period BP. The non-display period BP may be omitted since data voltages V_{RGB} are not output during the non-display period BP. The horizontal synchronizing signal Hsync defines a plurality of horizontal periods included in the display period DSP. The data voltages V_{RGB} are output from the data driver 400 in every horizontal period.

The gate driver 200 outputs a plurality of gate signals GSS1 to GSSn to the gate lines GL1 to GLn in response to the first control signal CONT1. The gate signals GSS1 to GSSn are pulse signals having different activation periods from each other. The pixels PX11 to PXnm are turned on in a pixel row unit. The data voltages V_{RGB} are substantially simultaneously applied to the pixels connected to the corresponding gate line in the pixel row unit. The display panel DP generates the image during each of the frame periods Fn−1, Fn, and Fn+1 in a line-by-line scanning mode.

The first control signal CONT1 includes a vertical start signal that starts an operation of the gate driver 200, a gate clock signal that determines an output timing of the gate voltage, and an output enable signal that determines an ON-pulse width of the gate voltage.

The gray-scale voltage generator 300 generates reference gray-scale voltages VGMA1 to VGMA18 related to the light transmittance of the pixels PX11 to PXnm, by using a first driving voltage AVDD and a second driving voltage VSS having a level lower than that of the first driving voltage AVDD. The level of the first driving voltage AVDD may be changed according to the display panel, and the second driving voltage VSS may be a ground voltage.

The data driver 400 receives the second control signal CONT2 and the image data R′G′B′. The data driver 400 converts the image data R′G′B′ to the data voltages V_{RGB} and applies the data voltages V_{RGB} to the data lines DL1 to DLm.

The second control signal CONT2 includes a horizontal start signal STH that starts an operation of the data driver 400, a polarity control signal POL that controls a polarity of the data voltages V_{RGB}, and an output start signal TP that determines an output timing of the data voltages V_{RGB} from the data driver 400.

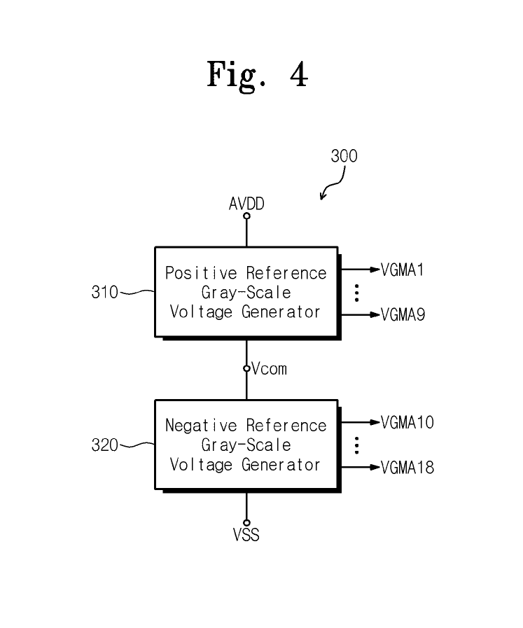

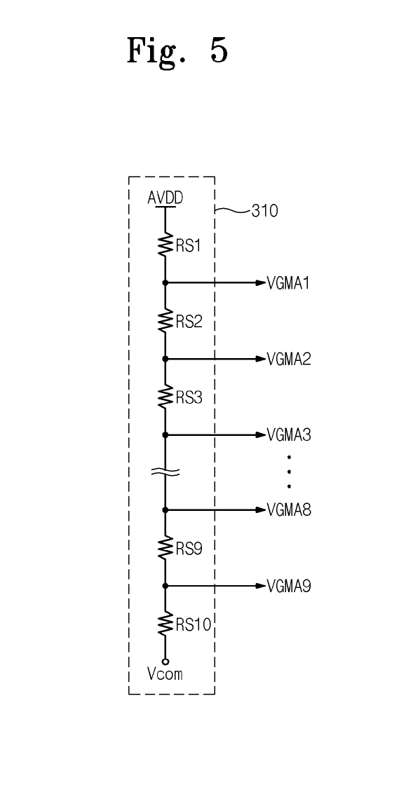

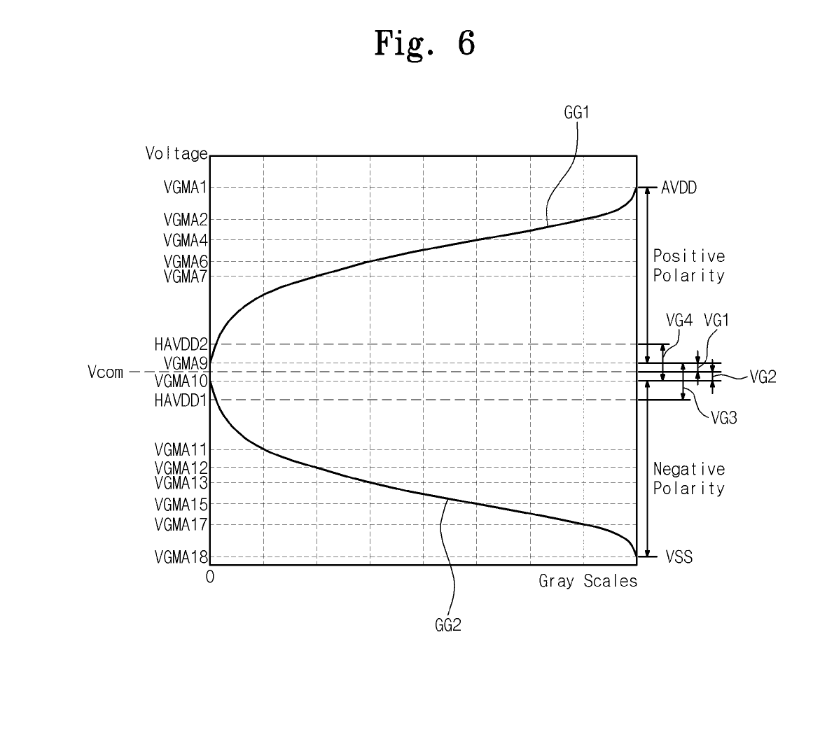

FIG. 4 is a block diagram showing the gray-scale voltage generator shown in FIG. 1, FIG. 5 is a circuit diagram showing a positive gray-scale voltage generator according to an exemplary embodiment of the present disclosure, and FIG. 6 is a gamma curve of a display device according to an exemplary embodiment of the present disclosure.

Referring to FIG. 4, the gray-scale voltage generator 300 includes a first reference gray-scale voltage generator 310 and a second reference gray-scale voltage generator 320. The first reference gray-scale voltage generator 310 generates a plurality of positive (+) reference gray-scale voltages VGMA1 to VGMA9 between the first driving voltage AVDD and the common voltage Vcom. The second reference gray-scale voltage generator 320 generates a plurality of negative (−) reference gray-scale voltages VGMA10 to VGMA18 between the common voltage Vcom and the second driving voltage VSS.

Referring to FIG. 5, the first reference gray-scale voltage generator 310 includes a plurality of resistors RS1 to RS10 connected to each other in series between the first driving voltage AVDD and the common voltage Vcom. The positive (+) reference gray-scale voltages VGMA1 to VGMA9 have different levels from each other between the first driving voltage AVDD and the common voltage Vcom, according to their corresponding voltage division ratios. Although not shown in the figures, the second reference gray-scale voltage generator 320 includes a plurality of resistors connected to each other in series between the common voltage Vcom and the second driving voltage VSS.

Referring to FIG. 6, the positive (+) reference gray-scale voltages VGMA1 to VGMA9 is represented by a gamma curve GG1 (hereinafter, referred to as a first gamma curve). The negative (−) reference gray-scale voltages VGMA10 to VGMA18 are represented by a gamma curve GG2 (hereinafter, referred to as a second gamma curve), which is symmetrical with the first gamma curve GG1 with respect to the common voltage Vcom.

Among the positive (+) reference gray-scale voltages VGMA1 to VGMA9, the reference gray-scale voltage VGMA9 having the lowest gray-scale level (hereinafter, referred to as positive lowest reference gray-scale voltage) has a voltage difference VG1 (hereinafter, referred to as a first voltage difference) with respect to the common voltage Vcom. Among the negative (−) reference gray-scale voltages VGMA10 to VGMA18, the reference gray-scale voltage VGMA10 having the lowest gray-scale level (hereinafter, referred to as negative lowest reference gray-scale voltage) has a voltage difference VG2 (hereinafter, referred to as a second voltage difference) with respect to the common voltage Vcom.

The data driver 400 (refer to FIG. 1) generates the data voltages V_{RGB} (refer to FIGS. 3A and 3B) corresponding to the image data R′G′B′ from the positive (+) reference gray-scale voltages VGMA1 to VGMA9 and/or the negative (−) reference gray-scale voltages VGMA10 to VGMA18. In this case, the data voltage having the lowest gray-scale level among the data voltages V_{RGB} is generated from the positive lowest reference gray-scale voltage VGMA9 or the negative lowest reference gray-scale voltage VGMA10.

Accordingly, the brightness at the lowest gray-scale is determined by the level of the positive lowest reference gray-scale voltage VGMA9 or the negative lowest reference gray-scale voltage VGMA10. As the first voltage difference VG1 and the second voltage difference VG2 decrease, the brightness at the lowest gray-scale becomes low, and thus each of the pixels PX11 to PXnm (refer to FIG. 1) displays a lowest gray-scale that is near a black level.

In a conventional display device, the first voltage difference VG1 and the second voltage difference VG2 are equal to or greater than about 0.5 volts due to the operating characteristics of the data driver 400. In the present exemplary embodiment, the first voltage difference VG1 and the second voltage difference VG2 can be equal to or smaller than about 0.5 volts.

Among the positive (+) reference gray-scale voltages VGMA1 to VGMA9, the reference gray-scale voltage VGMA1 having the highest gray-scale level has a voltage level equal to or slightly smaller than that of the first driving voltage AVDD. In addition, among the negative (−) reference gray-scale voltages VGMA10 to VGMA18, the reference gray-scale voltage VGMA18 having the highest gray-scale level has a voltage level equal to or slightly higher than that of the second driving voltage VSS.

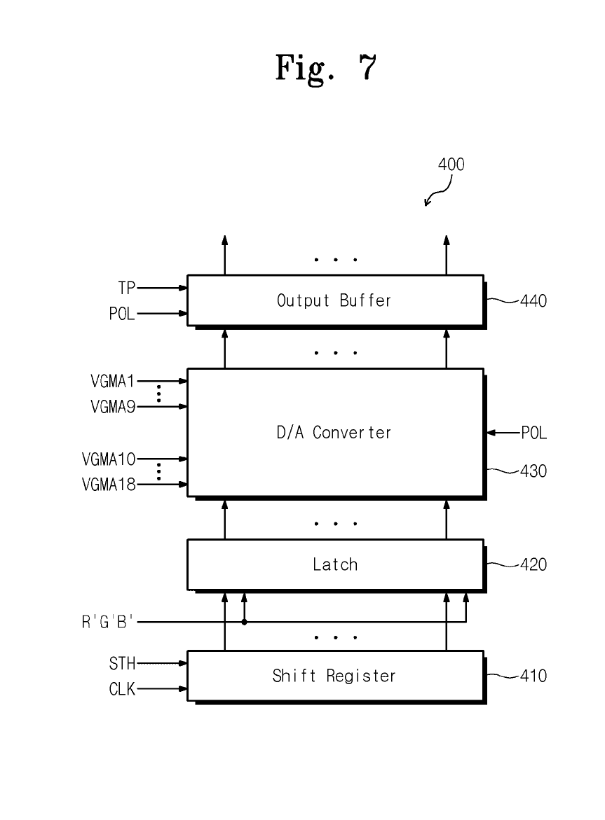

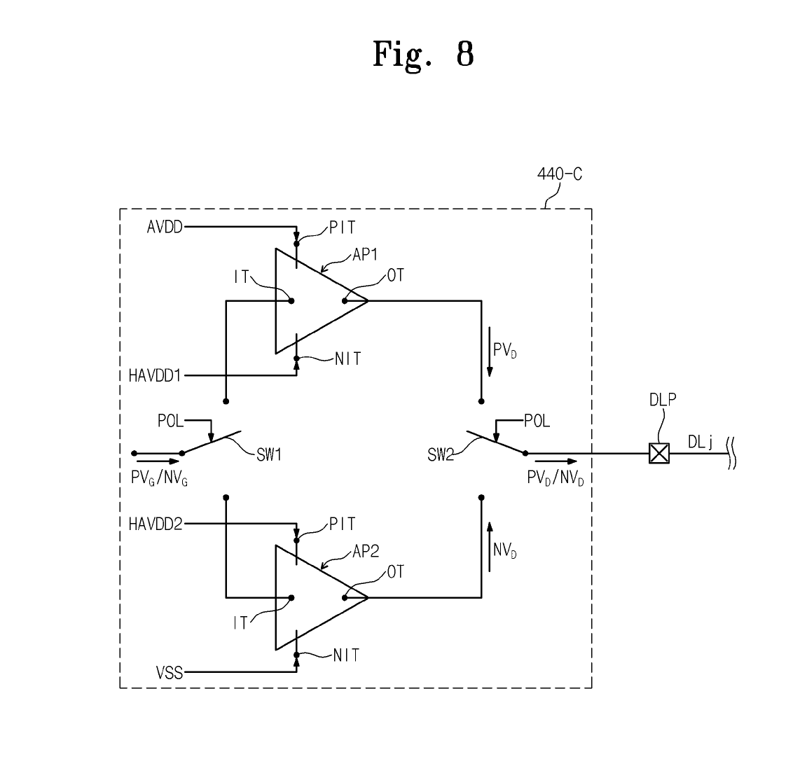

Hereinafter, the first and second voltage differences VG1 and VG2 will be described in detail with reference to FIGS. 7 and 8.

FIG. 7 is a block diagram showing the data driver 400 shown in FIG. 1 and FIG. 8 is a circuit diagram showing an output buffer of FIG. 7. Here, timings of the signals uenerated by the data driver 400 are as shown in FIG. 3B.

Referring to FIG. 7, the data driver 400 includes a shift register 410, a latch 420, a digital-to-analog converter 430 (hereinafter, referred to as a D/A converter), and an output buffer 440.

The shift register 410 includes plural stages (not shown) connected to each other one after another. The stages receive a data clock signal CLK. Among the stages, a first stage receives the horizontal start signal STH. When the first stage starts its operation in response to the horizontal start signal STH, the stages sequentially output control signals in response to the data clock signal CLK.

The latch 420 includes a plurality of latch circuits. The latch circuits sequentially receive the control signals from the stages. The latch 420 stores the image data R′G′B′ in the pixel row unit. Each of the latch circuits stores a corresponding portion of the image data R′G′B′ in response to a corresponding one of the control signals. The latch 420 provides the image data R′G′B′ stored in the pixel row units to the D/A converter 430.

The D/A converter 430 receives the positive (+) reference gray-scale voltages VGMA1 to VGMA9 and the negative (−) reference gray-scale voltages VGMA10 to VGMA18. Although not shown in figures, the D/A converter 430 may include a plurality of D/A converters respectively corresponding to the latch circuits. The D/A converter 430 converts the imaue data provided from the latch 420 to the gray-scale voltages.

The D/A converter 430 generates positive gray-scale voltages from the positive (+) reference gray-scale voltages VGMA1 to VGMA9, or negative gray-scale voltages from the negative (−) reference gray-scale voltages VGMA10 to VGMA18, in response to the polarity control signal POL. For instance, when the polarity control signal POL is at a high level, the D/A converter 430 generates the positive gray-scale voltages from the positive (+) reference gray-scale voltages VGMA1 to VGMA9. As shown in FIG. 3A, the polarity control signal POL is inverted every horizontal period and every frame period Fn−1, Fn, and Fn+1.

The D/A converter 430 includes a positive gray-scale voltage generator (not shown) to generate the positive gray-scale voltages, and a negative gray-scale voltage generator (not shown) to generate the negative gray-scale voltages. The positive gray-scale voltage generator outputs the positive gray-scale voltages corresponding to the image data of one pixel row in response to the polarity control signal POL.

Then, the negative gray-scale voltage generator outputs the negative gray-scale voltages corresponding to the image data for a subsequent pixel row in response to the polarity control signal POL. As described above, the D/A converter 430 alternately outputs the positive gray-scale voltages and the negative grays-scale voltages in response to the polarity control signal POL.

The output buffer 440 receives the gray-scale voltages from the D/A converter 430. The output buffer 440 buffers the gray-scale voltages and applies the gray-scale voltages to the data lines DL1 to DLm. The buffered gray-scale voltages correspond to the data voltages V_{RGB} described with reference to FIGS. 1 to 3B. The data voltages V_{RGB} may be amplified from the gray-scale voltages. The output buffer 440 substantially simultaneously outputs the data voltages corresponding to one pixel row to the data lines DL1 to DLm in response to the output start signal TP.

The output buffer 440 includes a plurality of buffer circuits, where the number of buffer circuits is the same number as the data lines DL1 to DLm. For convenience of explanation, only one buffer circuit 440-C has been shown in FIG. 8.

The buffer circuit 440-C includes a first amplifier AP1, a second amplifier AP2, a first switch SW1, and a second switch SW2. Each of the first and second amplifiers AP1 and AP2 includes an input terminal IT, an output terminal OT, a positive voltage input terminal PIT, and a negative voltage input terminal NIT.

The first switch SW1 selectively applies the corresponding gray-scale voltage output from the D/A converter 430 to the input terminal IT of the first amplifier AP1 and the input terminal IT of the second amplifier AP2. Responsive to the polarity control signal POL, the first switch SW1 applies a positive gray-scale voltage PV_{G} to the input terminal IT of the first amplifier AP1 and applies a negative gray-scale voltage NV_{G} to the input terminal IT of the second amplifier AP2.

Responsive to the polarity control signal POL, the second switch SW2 selectively connects the output terminal OT of the first amplifier AP1 or the output terminal OT of the second amplifier AP2 to the corresponding data line DLj. The buffer circuit 440-C applies the positive data voltage PV_{D} output from the first amplifier AP1 to the corresponding data line DLj, and then applies the negative data voltage NV_{D} output from the second amplifier AP2 to the corresponding data line DLj. The positive data voltage PV_{D} or the negative data voltage NV_{D} is applied to the corresponding data line DLj through a pad DLP.

The positive voltage input terminal PIT of the first amplifier AP1 receives the first driving voltage AVDD. The negative voltage input terminal NIT of the first amplifier AP1 receives a first voltage HAVDD1 lower than both the positive lowest reference gray scale voltage VGMA9 and the common voltage Vcom.

The relation between the first voltage HAVDD1 and the positive lowest reference gray-scale voltage VGMA9 has been shown in FIG. 6. A third voltage difference VG3 is the difference between the first voltage HAVDD 1 and the positive lowest reference gray-scale voltage VGMA9. The third voltage difference VG3 is in a range from about 0.5 volts to about 1 volts.

The first amplifier AP1 outputs the voltage difference between the first driving voltage AVDD and the first voltage HAVDD1. The data driver 400 may utilize the voltage having the small first voltage difference VG1 as the positive lowest reference gray-scale voltage VGMA9.

The data voltage with the positive lowest reference gray-scale, which is output from amplifiers of the conventional display device, may be no lower than the common voltage Vcom. Such amplifiers are not operated on the condition that the data voltage with the lowest gray-scale is smaller than the common voltage Vcom. To prevent the amplifier from malfunctioning, a voltage for which the first voltage difference VG1 is equal to or greater than about 0.5 volts is used as the positive lowest reference gray-scale voltage VGMA9.

On the other hand, although the first amplifier AP1 according to the present exemplary embodiment receives a lowest gray-scale voltage for which the first voltage difference VG1 is smaller than that of the conventional display device, the first amplifier AP1 outputs a lowest gray-scale data voltage that corresponds to the voltage having the small first voltage difference VG1. Since the positive data voltage representing the lowest gray-scale has a level higher than that of the first voltage HAVDD1 even though the positive data voltage that represents the lowest gray-scale has a level lower than that of the common voltage Vcom, the first amplifier AP1 operates normally.

In addition, the first amplifier AP1, which receives a voltage having a small voltage difference with respect to the common voltage Vcom as the lowest gray-scale voltage, outputs a positive data voltage PV_{D} having a lowest gray-scale level lower than that of a conventional display device. For instance, the first amplifier AP1 may receive a voltage having first voltage difference VG1 equal to or smaller than about 0.5 volts as the lowest gray-scale voltage. A pixel receiving positive data voltage PV_{D} having the lowest gray-scale level displays the lowest gray-scale in low brightness. Therefore, a contrast ratio of the pixel becomes higher.

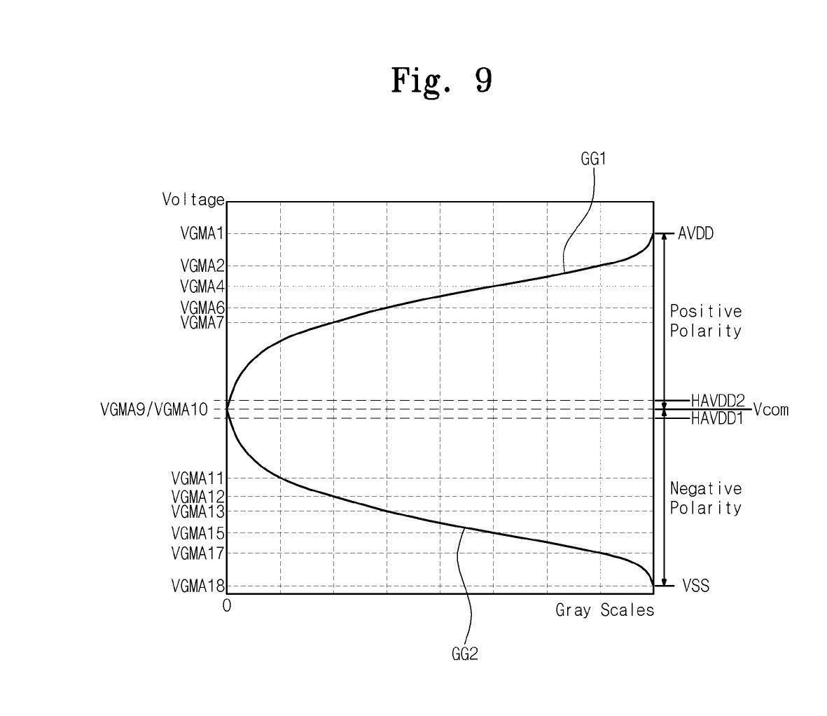

FIG. 9 is a gamma curve of a display device according to another exemplary embodiment of the present disclosure.

Referring to FIG. 9, the positive lowest reference gray-scale voltage VGMA9 may have the same level as that of the common voltage Vcom. Accordingly, a pixel receiving positive data voltage PV_{D} having the lowest gray-scale level displays the lowest gray-scale near black level.

Referring to FIG. 8, the positive voltage input terminal PIT of the second amplifier AP2 receives a second voltage HAVDD2 higher than the common voltage Vcom. The negative voltage input NIT of the second amplifier AP2 receives the second driving voltage VSS.

The relation between the second voltage HAVDD2 and the negative lowest reference gray-scale voltage VGMA10 has been shown in FIG. 6. A fourth voltage difference VG4 is the difference between the second voltage HAVDD2 and the negative lowest reference gray-scale voltage VGMA10. The fourth voltage difference VG4 is in a range from about 0.5 volts to about 1 volt.

The second amplifier AP2 outputs the voltage difference between the second driving voltage VSS and the second voltage HAVDD2. The data driver 400 may utilize a voltage having small second voltage difference VG2 as the negative lowest reference gray-scale voltage VGMA10.

Although the second amplifier AP2 receives a voltage having second voltage difference VG2 smaller than that of the conventional display device as the lowest gray-scale voltage, the second amplifier AP2 outputs a data voltage having a lowest gray-scale level that corresponds to the voltage having the small second voltage difference VG1. Since the negative data voltage representing the lowest gray-scale has a level lower than that of the second voltage HAVDD2 even though the negative data voltage that represents the lowest gray-scale has the level higher than that of the common voltage Vcom, the second amplifier AP2 operates normally.

In addition, the second amplifier AP2 receives a voltage having a small voltage difference with respect to the common voltage Vcom as the lowest gray-scale voltage, and outputs negative data voltage NV_{D} having a lowest gray-scale level lower than that of a conventional display device. For instance, the second amplifier AP2 may receive a voltage having a second voltage difference VG2 equal to or smaller than about 0.5 volts as the lowest gray-scale voltage. As shown in FIG. 9, the negative reference gray-scale voltage VGMA10 having the lowest gray-scale may have the same level as that of the common voltage Vcom.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display device comprising:
a display panel that includes a plurality of pixels each configured to receive both a common voltage and a data voltage that corresponds to image data;
a gray-scale voltage generator configured to generate a plurality of reference gray-scale voltages; and
a data driver configured to receive the image data and the reference gray-scale voltages and to generate the data voltage, wherein the data driver comprises a first amplifier having a first voltage input terminal configured to receive a first voltage, a second voltage input terminal configured to receive a second voltage lower than both the first voltage and the common voltage, an input terminal configured to receive a gray-scale voltage having a gray-scale level corresponding to the image data, and an output terminal configured to output the data voltage as a buffered voltage corresponding to the gray-scale voltage.

2. The display device of claim 1, wherein the gray-scale voltage generator is configured to receive the first voltage and a third voltage lower than the first voltage, and to generate the reference gray-scale voltages between the first voltage and the third voltage.

3. The display device of claim 2, wherein the reference gray-scale voltages comprise positive reference gray-scale voltages between the first voltage and the common voltage, and negative reference gray-scale voltages between the common voltage and the third voltage.

4. The display device of claim 3, wherein the second voltage is about 0.5 volts to about 1 volts less than that positive reference gray-scale voltage which has a lowest gray scale level from among the gray scale levels of the positive reference gray-scale voltages.

5. The display device of claim 4, wherein a voltage difference between the common voltage and that positive reference gray-scale voltage which has a lowest gray-scale level is about 0.5 volts.

6. The display device of claim 5, wherein that positive reference gray-scale voltage which has a lowest gray-scale level is substantially equal to the common voltage.

7. The display device of claim 5, wherein, when the gray-scale level of the image data is the lowest gray-scale level, a gray-scale voltage applied to the input terminal of the first amplifier has a same level as that positive reference gray-scale voltage which has a lowest gray-scale level.

8. The display device of claim 5, wherein:
the display panel comprises a plurality of gate lines connected to the pixels and a plurality of data lines connected to the pixels,
each of the pixels comprises a thin film transistor connected to a corresponding one of the gate lines and a corresponding one of the data lines, as well as a liquid crystal capacitor connected to the thin film transistor, and
the liquid crystal capacitor comprises a first electrode configured to receive a pixel voltage corresponding to the data voltage from the thin film transistor, as well as a second electrode configured to receive the common voltage.

9. The display device of claim 3, wherein the data driver comprises a second amplifier having a first voltage input terminal configured to receive a fourth voltage higher than the common voltage and lower than the first voltage, a second voltage input terminal configured to receive the third voltage, an input terminal configured to receive the gray-scale voltage, and an output terminal configured to output the data voltage as a buffered voltage corresponding to the gray-scale voltage.

10. The display device of claim 9, wherein the first amplifier is configured to output its data voltage having a positive polarity, the second amplifier is configured to output its data voltage having a negative polarity, and the data driver is configured to output the positive polarity data voltage and the negative polarity data voltage in alternating manner.

11. The display device of claim 10, wherein the fourth voltage is about 0.5 volts to about 1 volts greater than that negative reference gray-scale voltage which has a lowest gray-scale level from among the gray scale levels of the negative reference gray-scale voltages.

12. The display device of claim 11, wherein a voltage difference between the common voltage and that negative reference gray-scale voltage which has a lowest gray-scale level is about 0.5 volts.

13. A data driver comprising:
a shift register that includes a plurality of stages connected to each other one after another and that is configured to sequentially output control signals;
a latch configured to receive image data and to store the image data in a pixel row unit in response to the control signals;
a digital-to-analog converter configured to receive reference gray-scale voltages including positive reference gray-scale voltages and negative reference gray-scale voltages, and configured to convert the image data output from the latch to gray-scale voltages; and
an output buffer configured to output data voltages buffered from the gray-scale voltages to pixels of a display panel,
wherein the output buffer comprises a plurality of buffer circuits each including a first amplifier having a first voltage input terminal configured to receive a first voltage, a second voltage input terminal configured to receive a second voltage lower than both the first voltage and a common voltage for the pixels, an input terminal configured to receive a corresponding gray-scale voltage of the gray-scale voltages, and an output terminal configured to output a corresponding data voltage of the data voltages to a corresponding pixel of the pixels.

14. The display device of claim 13, wherein the digital-to-analog converter is configured to selectively output positive gray-scale voltages and negative gray-scale voltages corresponding to the image data in response to a polarity control signal.

15. The display device of claim 14, wherein the digital-to-analog converter is configured to output the positive gray-scale voltages and the negative gray-scale voltages in alternating manner.

16. The display device of claim 13, wherein each of the buffer circuits further comprises a second amplifier having a first voltage input terminal configured to receive a third voltage higher than the common voltage, a second voltage input terminal configured to receive a ground voltage, an input terminal configured to receive the corresponding gray-scale voltage, and an output terminal configured to output the corresponding data voltage as a buffered voltage corresponding to the corresponding gray-scale voltage.

17. The display device of claim 16, wherein each of the buffer circuits further comprises:
a first switch configured to selectively apply the corresponding gray-scale voltage to either the input terminal of the first amplifier or the input terminal of the second amplifier, according to the polarity control signal; and
a second switch configured to selectively connect either the output terminal of the first amplifier or the output terminal of the second amplifier to a data line connected to the corresponding pixel according to the polarity control signal.

18. The display device of claim 16, wherein the second voltage is about 0.5 volts to about 1 volts less than that positive reference gray-scale voltage which has a lowest gray scale level from among the gray scale levels of the positive reference gray-scale voltages, and the third voltage is about 0.5 volts to about 1 volts greater than that negative reference gray-scale voltage which has a lowest gray-scale level from among the gray scale levels of the negative reference gray-scale voltages.

19. The display device of claim 16, wherein a voltage difference between the common voltage and that positive reference gray-scale voltage which has a lowest gray-scale level is equal to or less than about 0.5 volts, and a voltage difference between the common voltage and that negative reference gray-scale voltage which has a lowest gray-scale level is equal to or greater than about 0.5 volts.
